(19) United States
(12) Patent Application Publication
(10) Pub. No.: US 2021/0039883 A1
(43) Pub. Date: Feb. 11, 2021

(54) OVERHEAD STORAGE ACCESS SYSTEM

(71) Applicant: Hall Labs LLC, Provo, UT (US)

(72) Inventors: David R. Hall, Provo, UT (US); Jerome Miles, Spanish Fork, UT (US); Corey Webb, Spanish Fork, UT (US); Casey Webb, Spanish Fork, UT (US)

(73) Assignee: Hall Labs LLC, Provo, UT (US)

(21) Appl. No.: 16/893,806

(22) Filed: Jun. 5, 2020

Related U.S. Application Data
(60) Provisional application No. 62/884,125, filed on Aug. 7, 2019.

(51) Int. Cl. B65G 1/06; B66F 7/02; B66D 1/12; B66F 7/28

(52) U.S. Cl. CPC B65G 1/06; B66F 7/02; E04B 9/003; B66F 7/28; B66D 1/12

(57) ABSTRACT

A system for lifting and lowering a load between a position in a room to a position in a storage space above the room is disclosed. The system includes: a first and second beam each attached to an underside or side of two ceiling joists. The first and second beams are installed from below without requiring access above the joists. The system also includes a first vertical frame member connected to and supported by the first beam, a second vertical frame member connected to and supported by the second beam, and a horizontal frame member connected to a top portion of each of vertical frame members. The system also includes a platform for supporting the load and a lifting device for raising and lowering the load.

### CROSS-REFERENCE TO RELATED APPLICATION

The present application claims is a continuation-in-part of U.S. Provisional Patent Application No. 62/884,125, filed Aug. 7, 2019 and entitled Overhead Storage Access System, the entire disclosure of which is incorporated herein by reference.

### TECHNICAL FIELD

This invention relates generally to accessing overhead storage.

### BACKGROUND

The attic is often an underutilized space for storing belongings. There are many reasons that attics are not used for storage. Attics are often difficult to access, and especially so when it comes to moving belongings into such a space. If there is access it is often a small hole that is difficult to climb through, let alone maneuver objects through. However, an attic can be an ideal place for storing belongings.

### SUMMARY

Embodiments of the present disclosure are directed to an overhead storage access system. The system includes a stationary component having a first and a second beam, each beam attached to an underside or vertical side of two parallel joists in a ceiling. The first and second beams are spaced apart and aligned generally transverse to the two joists. The stationary component also has first and second vertical frame members attached to and extending upward from the first and second beams, respectively. The stationary component also includes a horizontal member coupled to the vertical frame members and extending horizontally from the vertical frame. The system also includes a lift configured to be movably coupled to the stationary component. The lift is movable between a raised position above the ceiling and a lowered position below the ceiling. The lift includes a platform for carrying a load to be stored, a lifting pillar coupled to the platform and extending upward defining a storage area configured to receive the load on the platform, and one or more lifting devices coupled between the stationary component and the lift. The one or more lifting devices includes a motor driving a drum and a line that is wound around the drum to raise the lift and unwound from around the drum to lower the lift. The motor is configured to raise and lower the lift in response to an instruction from a controller.

Other embodiments of the present disclosure are directed to an overhead storage access system including beams attached to joists in a ceiling that are transverse to the joists and are attached to an underside of the joists from below the joists. The system also includes frame members coupled to the beams and extending upwardly from the beams, a lifting device coupled to the frame members, and a platform coupled to the lifting device and being configured to raise and lower relative to the beams and frame members as directed by the lifting device.

Still further embodiments of the present disclosure are directed to a method of installing an overhead storage access unit that includes attaching a first beam to two parallel, spaced apart joists in a ceiling, attaching a second beam to the same two joists, with the first and second beams attached to at least one of an underside of the joists, a vertical side region of the joists, or both the underside and vertical side region of the joists. The method also includes attaching a lifting device to the beams, and attaching a lift to the lifting device that is configured to raise and lower the lift relative to the beams between a raised and lowered position.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is view of the lifting apparatus attached to two ceiling joists according to embodiments of the present disclosure.

FIG. 2 is an exploded view of the lifting apparatus according to embodiments of the present disclosure.

FIG. 3 is a view of the lifting apparatus with the lifting platform lowered according to embodiments of the present disclosure.

FIG. 4 is a view of the lifting platform partially raised according to embodiments of the present disclosure.

FIG. 5 is a view of the lifting platform fully raised according to embodiments of the present disclosure.

FIG. 6 is a view of a controller for use with the lifting platform according to embodiments of the present disclosure.

FIG. 7 is a view of the base of the lifting platform with a light installed on the bottom according to embodiments of the present disclosure.

FIG. 8 is a view of the base of the lifting platform with a drawer storage system installed on the bottom according to embodiments of the present disclosure.

FIG. 9 is a view of a cover for an opening in a ceiling according to embodiments of the present disclosure.

FIG. 10 is a view of a panel attached to the lifting platform to cover a hole in a ceiling according to embodiments of the present disclosure.

FIG. 11 is a view of the platform with hinges on the platform base frame according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “winch” or “lifting device” is meant to refer to devices with a motor attached to a drum for winding a line onto. One example of such lifting devices is available from MyLifter® and are described in U.S. Pat. Nos. 9,399,566; 9,567,195; 9,975,745 the contents of which are incorporated by reference.

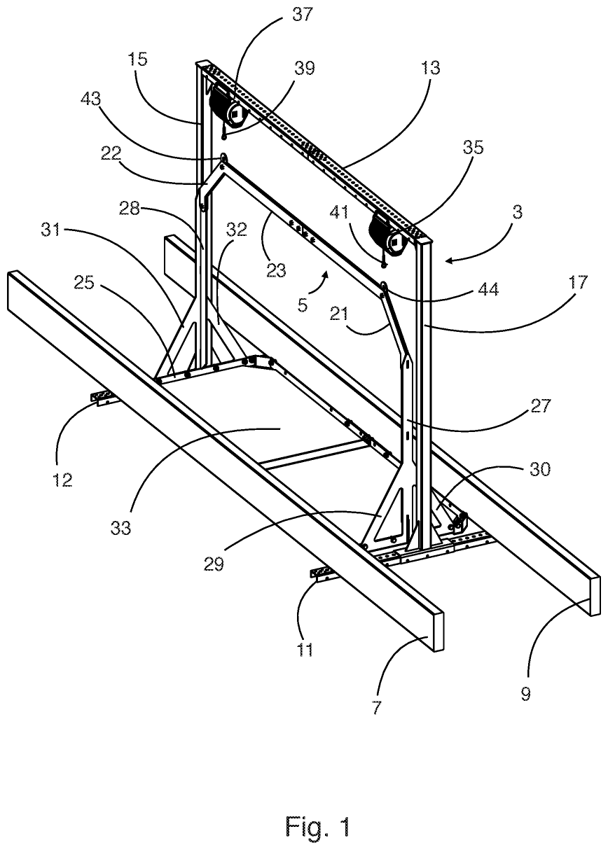

FIG. 1 is an isometric view of an overhead storage unit 2 according to embodiments of the present disclosure. The overhead storage unit 2 includes a stationary component that is secured to joists 7 and 9 in the attic or other ceiling structure, and a lift that is attached to the stationary component. The overhead storage unit 2 also includes one or more lifting devices 35, 37 that raise and lower the lift relative to the stationary component.

The stationary component includes beams 11 and 12. The beams 11, 12 may be part of an overhead mounting system such as that described in U.S. Pat. No. 9,939,105. A brief summary of the overhead mounting system follows. The beams 11 and 12 are U-shaped channels where the open portion of the U is oriented downward. The base of the U is the portion through which a lug bolt is attached to a ceiling, preferably attaching to a ceiling beam, such as ceiling joists 7 and 9. The sides of the u-shaped channel have multiple holes to which various devices are attached to the beam. Generally, when attaching devices to the beams the device is designed with a bracket that fits around the outside of the U-shaped channel and has complementary holes so that pins are inserted through the holes in one side of the bracket, then through the corresponding holes in the first side of the U-shaped channel, then through the holes in the second side of the U-shaped channel, and finally through the holes in the second side of the bracket. Preferably, the devices are held on with pins. In some embodiments, bolts are used in place of the pins. In other embodiments, the brackets have pins molded in them in place of the holes.

The stationary component also includes vertical frame members 15, 17, horizontal member 13. The lift includes lifting pillars 27, 28, angled members 21, 22, and horizontal member 23. The vertical frame members and horizontal member can be separate pieces of material fastened or welded together, or they can be constructed from a single piece of material. Angled alignment portions 29 and 31 can also be part of the lift to allow the lift to be properly aligned in the ceiling. The lift also includes a platform 33 that The lifting devices 35, 37 can be attached to the lift or to the stationary component.

The structure of the beams 11, 12 allow the stationary component to be installed to the joists to the bottom of the joists, or to a vertical side portion 19 of the joists 7, 9. The stationary component and lift together can be a kit that is easily installed from below the joists, without requiring the installer to enter the area above the joists. Contrasting to other systems which require entry into the attic and require components to rest on the floor of the attic above the overhead storage unit, the embodiments of the present disclosure require far less installation expertise and access.

The overhead storage unit 2 can be configured to raise and lower loads from a room into a space above the room. The load is lifted and lowered through an opening in the ceiling. The opening is generally made between two ceiling joists. The beams 11 and 12 span the distance between the ceiling joists 7 and 9. In the described embodiment two sides of the opening are ceiling joists 7, 9, and two other sides are beams 11 and 12. The beams 11, 12 can be transverse to the joists 7, 9. In some embodiments the beams 11, 12 are attached to two adjacent joists, 7, 9. In other embodiments the beams 11, 12 are attached to two non-adjacent joists.

The lifting frame 3 has a first vertical frame member 15 that connects to and is supported by beam 12. A second vertical frame member 17 connects to and is supported by beam 11. The vertical frame members 15 and 17 attach to a horizontal frame member 13. The vertical frame member 15 and 17 and the horizontal frame member 13 are preferably constructed in a lightweight yet strong manner, preferably a metal rectangular tube. Preferably, the metal is steel. More preferably the steel is powder coated. In other embodiments the lifting frame is constructed from other metals such as aluminum, titanium, or alloys of aluminum or titanium. Alternatively, the embodiments with aluminum or titanium are constructed with anodized aluminum or titanium. Another alternative embodiment uses composite materials such as carbon fiber or plastic. In other embodiments the lifting frame is constructed of solid pieces, with any of the previously mentioned materials.

In the preferred embodiment a first winch or lifting device 35 is attached to the horizontal frame member 13, and a second winch or lifting device 37 is also attached to the horizontal frame member 13. In other embodiments a single lifting device can be used, and the lines (such as cables, wires, chains, ropes, etc.) or other attachment means can be distributed along a length of the vertical member 13 to balance the load. To enable the overhead storage unit 2 to lift and lower in a level manner, the lifting devices coordinate their actions so that they spool their lines in at the same speed. The lifters are programmed with certain functionalities as to enable the lifters to function as a group (such as those described in U.S. Pat. No. 10,280,051, the contents of which are incorporated by reference)

In some embodiments of the present disclosure, multiple motorized lifting devices are configured to lift and lower a shared load, such as the lifting platform. When using multiple synchronizing motorized lifting devices to lift a shared load, apparatus and methods are needed to ensure that the motorized lifting devices stay synchronized. For example, if one motorized lifting device were to stop while the other motorized lifting devices continued raising or lowering a load, the lifting platform could tip, potentially creating a safety hazard. A similar situation could occur if some motorized lifting devices were to move faster or slower than others.

In an alternative embodiment the lifting devices are attached to the vertical frame member. By attaching the lifting devices to the vertical frame members more space is made available on the lifting platform for storing items on the attic lift. In embodiments where the lifting devices are attached to the vertical frame members pulley are added to the horizontal frame member. Additionally, when the lifting devices are located on the vertical frame members the lines of the lifting devices need to be extended to accommodate the additional distance the lifters will be from the line attachment locations. In yet another embodiment, the horizontal frame member extends past the vertical frame members and the lifting devices are attached to the portions of the horizontal frame member that extend past the vertical frame members.

In certain embodiments, a single lifting device is attached to the lifting frame for lifting and lowering the lifting platform. This single lifting is attached to the horizontal frame member in some embodiments and in other embodiments is attached to either vertical frame member.

The lifting devices have lines 39 and 41 which attach to a platform 5 for supporting objects. This platform may also be referred to as a lifting platform. The lifting platform 5 is composed of several elements. A platform base frame 25 attaches to lifting pillars 27 and 28. The lifting pillars 27 and 28 are constructed to help the lifting platform 5 self-align into the holding space. To self-align the lifting platform 5 as it is lifted in to the holding space the lifting pillars 27 and 28 include angled sections 21 and 22. The angled portions 21 and 22 ensure that as the lifting platform 5 is lifted the lifting platform 5 will slide into the space between the beams 11 and 12. As the platform 5 is lifted there are conditions where the platform 5 will swing along the long axis of the platform. When this occurs the angled potions 21 and 22 will keep the lifting platform 5 from hanging up on either beam 11 or 12, by allowing the lifting pillars 27 or 28 to slide along beams 11 or 12. The lifting pillars 27 and 28 are connected by a horizontal lifting bar 23.

Lifting pillars 27 and 28 also include lower alignment portions 29, 30, 31, and 32. Under conditions where the lifting platform 5 swings along the short axis of the lifting platform 5 the lower alignment portions ensure that the lifting platform 5 will not hang up on the ceiling joists or beams 7 and 9. The angled orientation of the lower alignment portions 29, 30, 31, and 32 enables the lifting platform to slide up along either of the ceiling joists 7 or 9 without binding up on the ceiling beam 7 or 9.

The lifting platform 5 includes a platform base frame 25. The platform base frame 25 supports a platform base 33. The platform base 33 enables items to be placed on the lifting platform 5 so that items will not fall through the lifting platform 5. The lifting pillars 27 and 28 attach to the platform base frame 25. The parts of the lifting platform 5 are generally attached together with nuts and bolts. For example, the lifting pillars 27 and 28 are bolted to the platform base frame 25. The lifting platform 5 is preferably made from durable materials that provide support. In preferred embodiments the lifting platform 5 is made from metal. Preferably that metal is steel. In most embodiments where steel is the frame material, the steel is covered with a protective coating such as a powder coat. Other protective coatings include rubber, paint, and galvanization. In other embodiments the lifting platform 5 is made from other metals such as aluminum or titanium. In some embodiments utilizing aluminum or titanium it is advantageous to protect the aluminum or titanium. Such protections include anodization or coatings.

In some embodiments the lines of the lifting devices attach directly to the line attachment locations 43 and 44. The line attachment locations 43 and 44 are preferably eye bolts. Alternatively, the line attachment locations are manufactured into the horizontal lifting bar 23. In yet another embodiment, the lines run through pulleys connected to the lifting platform. These pulleys attach at the line attachment locations. The use of pulleys enables the lifting platform to lift and lower more weight. The use of pulleys on the lifting platform increases the mechanical advantage and therefore allows the platform to hold more weight while the lifting devices are doing the same amount of work. The use of a single pulley on a line approximately doubles the weight that the corresponding lifting device can lift and lower.

In some embodiments the vertical frame members 15 and 17, frame brackets 18 and 16, horizontal frame member 13, are collectively referred to as a stationary frame. Lifting pillars 27, horizontal lifting bar 23, and alignment portions 22, 27, and 29 are collectively referred to as a movable frame.

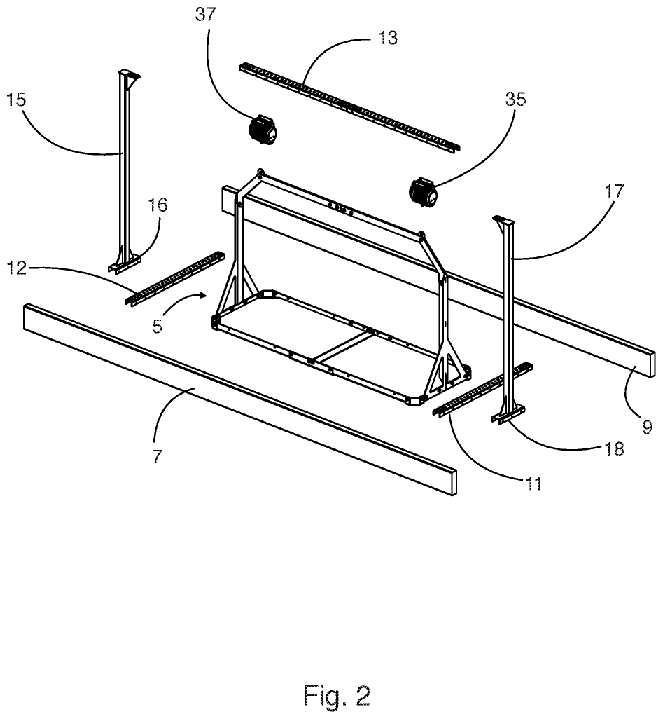

FIG. 2 is an exploded view of the lifting frame of the attic lifter. The lifting frame 3 attaches to beams 11 and 12. The beams 11 and 12 are U-shaped channels where the open portion of the U is oriented downward. The base of the U is the portion through which a lug bolt is attached to a ceiling beam or joist, such as ceiling joists 7 and 9. The sides of the U-shaped channel have multiple holes to which various devices are attached to the beam. Generally, when attaching devices to the beams the device is designed with a bracket that fits around the outside of the U-shaped channel and has complementary holes so that pins are inserted through the holes in one side of the bracket, then through the corresponding holes in the first side of the U-shaped channel, then through the holes in the second side of the U-shaped channel, and finally through the holes in the second side of the bracket. Preferably, the devices are held on with pins. In some embodiments, bolts are used in place of the pins. In other embodiments, the brackets have pins molded in them in place of the holes.

The lifting frame 3 has two vertical frame members 15 and 17 that sit on and attach to beams 11 and 12. At the base of lifting pillar 15 is bracket 16. Bracket 16 fits on beam 12. The bracket 16 includes holes that correspond to holes in the beam 12. The corresponding holes in the bracket 16 and the beam 12 are designed to accommodate pins which secure the bracket 16 in place on the beam 12. On the other side of the lifting frame bracket 18 is incorporated into vertical frame member 17. The bracket 18 attaches to the beam 11. The bracket 18 includes holes that correspond to holes in the beam 11. The corresponding holes in the bracket 18 and the beam 11 are designed to accommodate pins which secure the bracket 18 in place on the beam 11.

One of the advantages of the present disclosure is the method for installing the lifting frame 3. Many attics are small and cramped. There is generally little room in an attic to maneuver, this can make building and installing things in an attic space very difficult. The systems and methods of the present disclosure are designed to be installed without ever entering the attic. Firstly, a person decides where to place their attic lifter. An opening is then cut in the ceiling to accommodate the lifting apparatus. Then the beams 11 and 12 are installed. Generally, the beams 11 and 12 will span the distance between two ceiling joists such as joists 7 and 9. Preferably, the beams 11 and 12 are attached to the ceiling joists 7 and 9 by lug bolts. The beams 11 and 12 have holes in them to accommodate lug bolts. The holes are spaced to easily allow installation in the ceiling joists. Typically, two lug bolts are used on each beam to install them into the ceiling joists. For example, beam 11 would have one lug bolt attached to ceiling joist 7 and one lug bolt attached to ceiling joist 9. The same is true for beam 12. The lifting frame 3 is attached together and then connected to the beams 11 and 12. Vertical frame members 15 and 17 are attached to horizontal frame member 13. The lifting devices 35 and 37 are attached to the horizontal frame member. When the parts of the lifting fame 3 are attached together, the lifting frame 3 is lifted through the opening. At the base of vertical frame member 15 is bracket 16. At the base of vertical member 17 is bracket 18. Once lifted through the opening bracket 16 is fit on and attached to beam 12, while bracket 18 is fit on and attached to beam 11. The brackets 16 and 18 have holes that correspond to holes in the side beams 11 and 12. Preferably, pins are used to secure the brackets 16 and 18 to the beams 11 and 12. After attaching the lifting frame 3 to the beams 11 and 12, the lines of lifting devices 35 and 37 are lowered and attached to the lifting platform.

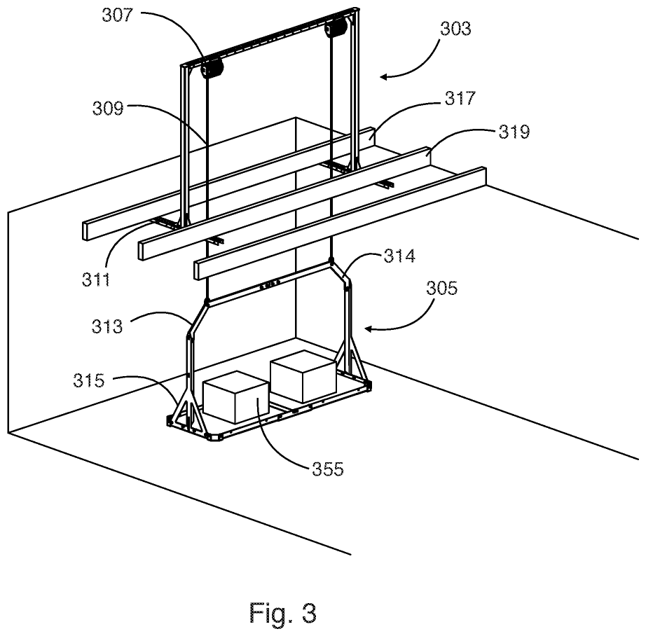

The overhead storage access device 2 is used to lift items from a location and store them in the ceiling of that location. FIGS. 3-5 show the lifting platform 305 in various stages of lowered and lifted positions. First in FIG. 3 the lifting platform is lowered to the floor. When the lifting platform is lowered it is easier to load items on the lifting platform 305. For example, the lifting platform is loaded with boxes such as box 355. Any item that fits within the dimensions of the lifting platform 305 is able to be lifted and stored on the lifting platform 305.

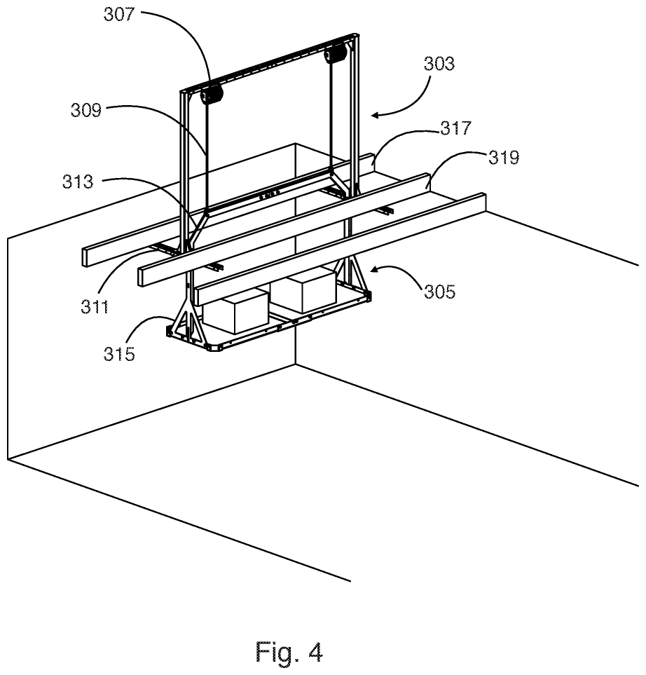

As the lifting platform is raised as shown in FIG. 4 the angled portions 313 and 314 of the lifting pillars assist in aligning the lifting platform 305 to slide into the storage space. The beams of the lifting frame such as the beam 311 attach to the bottom of ceiling joists such as ceiling joists 317 and 319. With the lifting frame beams attaching to the base of the ceiling joists, the lifting frame beams provide a surface on which the angled portion of the lifting frame can slide. For example, as the lifting platform 305 is lifted by the lifting devices, such as lifting device 307, the lifting platform 305 can move from left to right or back and forth. As the platform swings or is raised unevenly the angled portions 313 and 314 come into contact with the lifting frame beam 311. Due to the angled nature of the angled portion 313 of the lifting pillar, as the angled portion contacts the lifting frame beam 311, the lifting platform will not be caught up on the lifting frame beam 311. Keeping the lifting platform 305 from catching on the lifting frame beam protects the lifting devices. In instances when the lifting platform gets caught up on the lifting frame beam, many problems can occur such as stripping the gears in the lifting device, burning up the motor in the lifting device, stretching the line of the lifting device, pulling the line out of the lifting device, or many other issues. By constructing the lifting platform 305 with the angled portions, such as angled portion 313, the probability of encountering these problems is reduced. Additionally, the angled portions 313 and 314 of the lifting platform 305 protect the items on the lifting platform 305.

When the lifting platform is fully lifted, it settles into the space between the ceiling joists 317 and 319. Alternatively, in some embodiments the platform is lifted so that the base of the platform is above the top of the ceiling joists. The lifting devices such as lifting devices 307, are constructed so that the line will only spool or unspool when the motor is rotating. In other words, the gears of the lifting device are geared so that they will turn only when the motor rotates them. This effectively acts as a lock keeping the platform in place.

In an alternative embodiment the platform includes a locking mechanism that locks the platform into the lifted position. By including a locking mechanism, the platform can be kept in place without relying on the lifting devices. The locking mechanism can secure the lifting platform 5 to any one or more of the joists, beams, U-channels, or another suitable permanent, load-bearing ceiling structure to support the weight of the load. A latch or bar can be used to extend over the support structure so the load rests on the support rather than weighing on the lifting device 307.

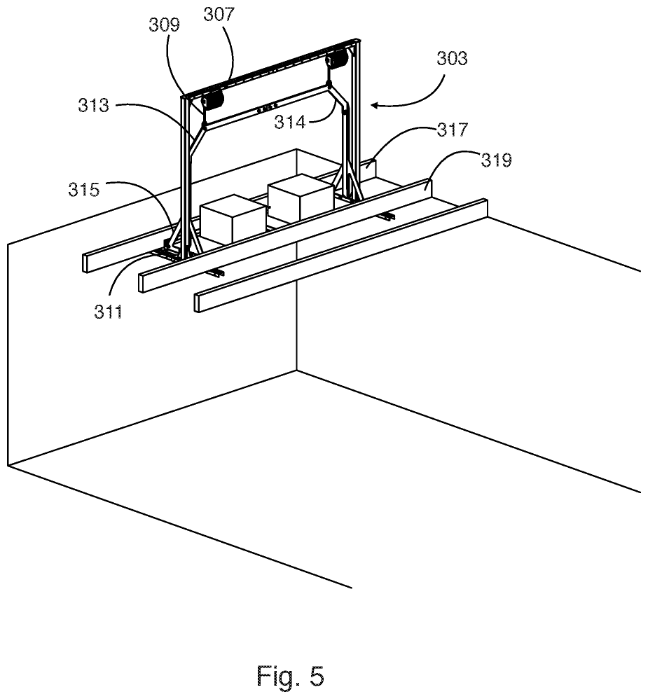

FIG. 5 is shows the lifting platform of FIGS. 3 and 4 in a raised position with items to be stored on the lifting platform according to embodiments of the present disclosure. The items fit between the joists 317 and 319 and are conveniently stored out of the way.

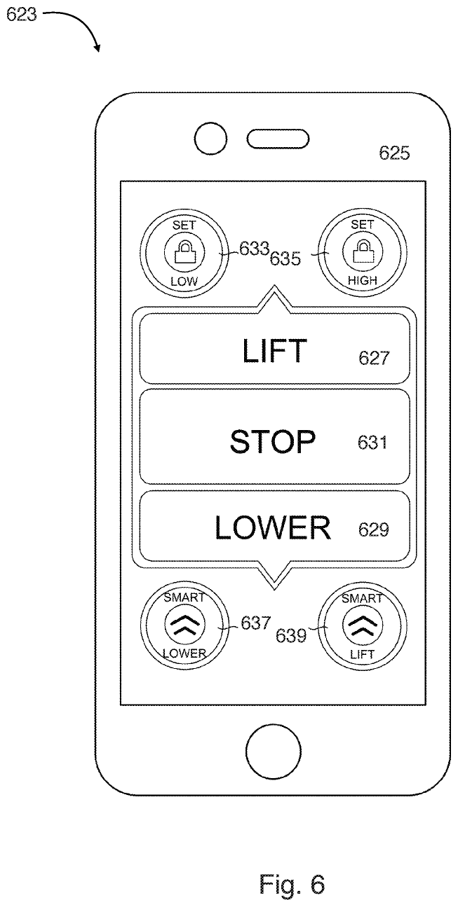

FIG. 6 is a schematic depiction of a smartphone 625 running an app to control the overhead storage unit 2 according to embodiments of the present disclosure. The app can include buttons for commands such as LIFT 627, STOP 631, LOWER 629, and other controls. There can be buttons for locking individual lifting devices 633 and 635, and buttons for raising or lowering individual lifting devices 637 and 639. The app can be configured to wirelessly communicate with the lifting devices to operate the overhead storage unit according to embodiments of the present disclosure.

The depicted user interface 625 also includes buttons that enable the motorized lifting devices to function in a more intelligent manner. For example, the user interface 625 includes functionality enabling a user to establish various set points for the motorized lifting devices and have the motorized lifting devices automatically stop at these set points as it raises or lowers the lifting platform. For example, a “set low” button 633 establishes a low set point at a user determined location of the line. Generally, this low set point will be at the point where the lifting platform is resting on the floor of a room. Alternatively, this set low point can be set at a convenient height for the user to reach so that bending over is not required to place things on the lifting platform. When the line is at desired location the user presses and holds the set low button, thus establishing the set low location. This location can be “locked” so that the location is not accidentally reset. Similarly, a “set high” button 635 establishes a high set point at a user determined location of the line. When the line is at desired location the user presses and holds the set high button, thus establishing the set high location. This location can be “locked” so that the location is not accidentally reset.

A “smart lower” button 637 causes the motorized lifting device to lower the line until it reaches the low set point and a “smart lift” button 639 causes the motorized lifting device to raise the line until it reaches the high set point. In other embodiments, the user interface 625 is configured to enable a user to establish other intermediate set points in addition to the high and low set points. Unlike the “lift” button 627 and the “lower” button 629, a user is not be required to hold down the “smart lower” button 627 or “smart lift” button 629 to perform the associated functions.

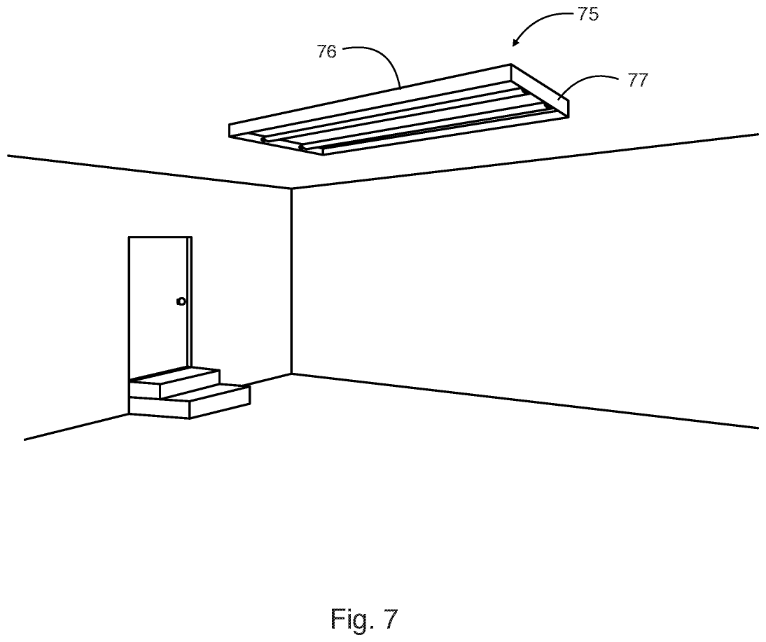

FIG. 7 is a covering that disguises the underside of the platform. The frame has long sides 76 which attach to the base of the platform. Alternatively, the frame attaches to the underside of the ceiling. The short sides of the frame 77 are coverings for the beams of the lifting frame. By creating a frame to which the beams are incorporated the beams are disguised and appear to be a natural part of appliances in the room. In some embodiments, the frame is decorative and looks like an embellishment on the ceiling of the room. In other embodiments, the frame is decorative and functional, for example, a light 75 that attaches to and covers the underside of the platform.

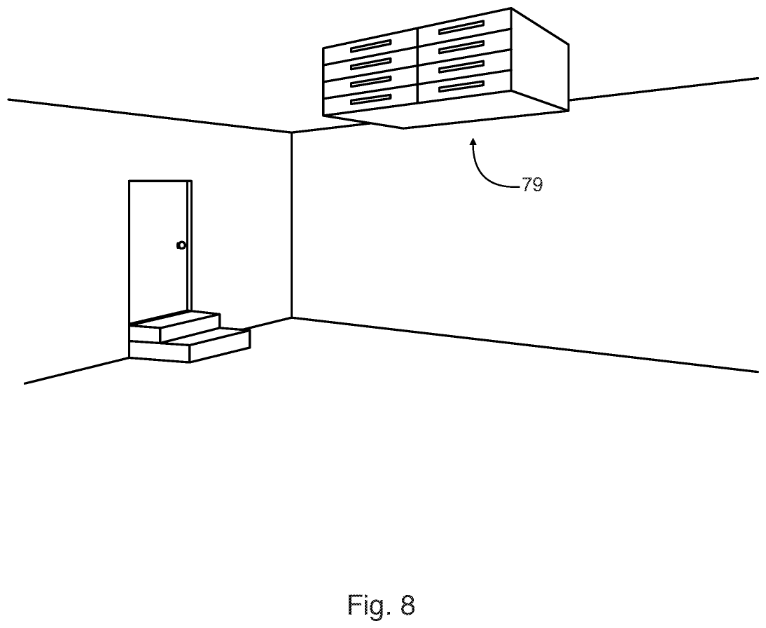

FIG. 8 shows another embodiment of the platform with a drawer system 79 attached to the lifting platform. This embodiment is particularly useful in garages where storing items overhead is a viable alternative to storing things on the floor. By placing a drawer storage system on the underside of the lifting platform storage space can be better utilized. An especially effective method is to store a large item on the lifting platform and store smaller accessories, or items associated with the large item in the drawers. The drawer system is customizable so that many options for drawers and their configuration is possible when utilizing a drawer system as the base cover for the lifting platform.

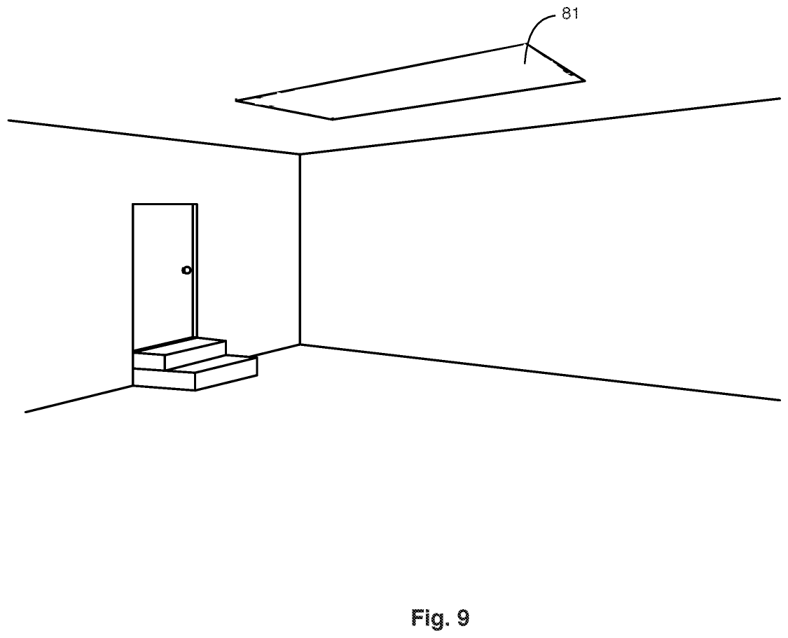

In many embodiments, the underside of the lifting platform, or the side that is visible in the room, will include a cover to disguise the hole in the ceiling. FIG. 9 shows the cover 81 covering the hole in the ceiling. There are two general options for cover. Often the cover is a panel that looks like the ceiling, thus camouflaging the hole in the ceiling. Alternatively, the cover is designed to keep the lifting platform from sliding on the floor, it will include protrusions that act as feet. The feet and cover will be made of rubber or another material that is non-slip and cushioning. With the cover in place the hole is less obvious. In some embodiments, the cover is insulated. In other embodiments the cover is partially insulated such as around the edges of the cover.

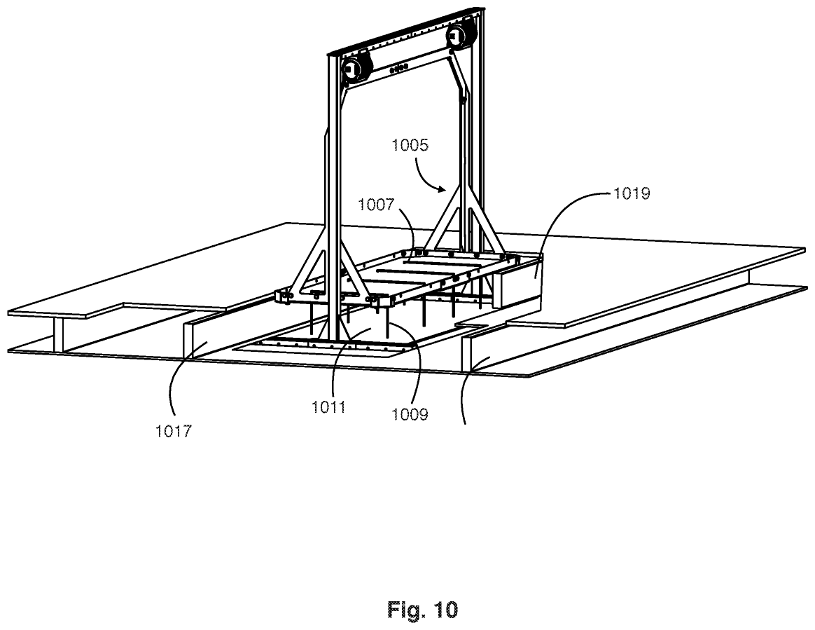

FIG. 9 shows how a cover 81 is kept in place against the ceiling. FIG. 10 shows a cut-away view of the overhead storage unit according to embodiments of the present disclosure. As the lifting platform 1005 is raised the platform base 1007 is brought level with the top of the ceiling joists 1017 and 1019. Ceiling cover 1011 is designed so it is larger than the hole in the ceiling. As the lifting platform 1005 is lifted up the cover 1011 sits snuggly against the ceiling. In the pictured embodiment, the cover 1011 is held against the ceiling by elastic bands or shock cords, such as shock cord 1009. The shock cords stretch so that the cover 1011 will not be broken by the force pulling it against the ceiling. The shock cords are sufficiently strong to keep the panel snug against the ceiling. As the lifting platform is lowered the shock cords will return to their pre stretched state and the cover will be held against the base of the lifting platform. Other embodiments utilize other materials to securely snug the cover to the ceiling, these materials include; springs, ratchets, and ropes.

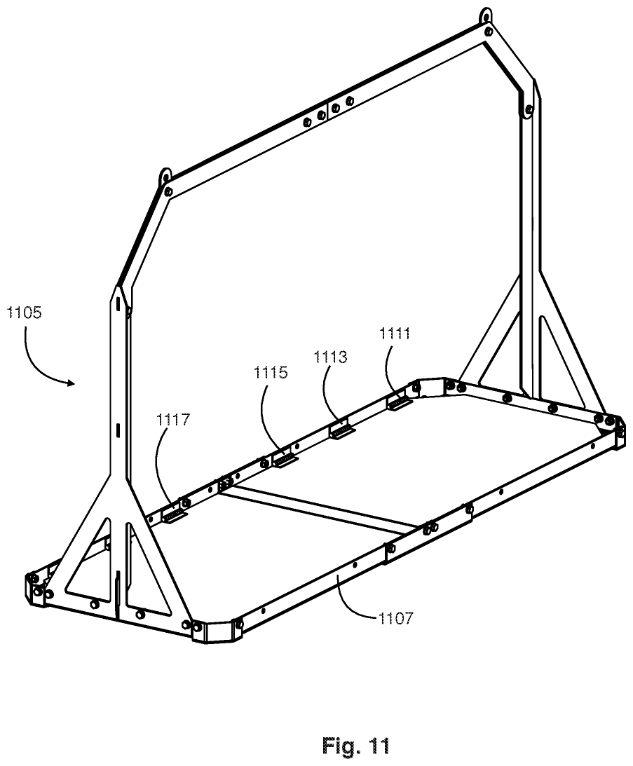

FIG. 11 shows yet other embodiments of the overhead storage unit according to embodiments of the present disclosure. In some embodiments, it will be useful to lift objects and take them off the lifting platform. The lifting platform may have a platform base frame 1107 around the base of the lifting platform 1105. The base forms a lip so that objects placed on the lifting platform 1105 cannot slide off. This lip is especially useful for items with wheel such as lawn mowers. In some circumstances this lip will make removing objects from the lifting platform 1105 more difficult because the lip will impede the objects from sliding. Lifting platform base frame 1107 includes hinges 1111, 1113, 1115, and 1117 to enable the side or lip of the base frame to fold down. This removes the lip and allows objects to be more easily slid off of the lifting platform.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. An overhead storage access system, comprising:
a stationary component, comprising:
a first and a second beam, each beam attached to an underside or vertical side of two joists in a ceiling, wherein the first and second beams are spaced apart and aligned generally transverse to the two joists;
a first and a second vertical frame member, attached to and extending upward from the first and second beams, respectively;
a horizontal member coupled to the vertical frame members and extending horizontally from the vertical frame;
a lift configured to be movably coupled to the stationary component, wherein the lift is movable between a raised position above the ceiling and a lowered position below the ceiling, the lift comprising:
a platform for carrying a load to be stored;
a lifting pillar coupled to the platform and extending upward defining a storage area configured to receive the load on the platform; and
one or more lifting devices coupled between the stationary component and the lift, wherein the one or more lifting devices comprises a motor driving a drum and a line that is wound around the drum to raise the lift and unwound from around the drum to lower the lift, and wherein the motor is configured to raise and lower the lift in response to an instruction from a controller.

2. The overhead storage access system of claim 1 wherein the stationary component is secured to two adjacent, spaced apart joists with a portion of the ceiling between the joists removed, defining an access hatch in the ceiling.

3. The overhead storage access system of claim 1, further comprising first angled portions oriented parallel to the joists and second angled portions oriented perpendicular to the joists, wherein the angled portions are between the horizontal frame member and a vertical frame member.

4. The overhead storage access system of claim 1 wherein the beams comprise U-channels having a flat bottom, wherein the flat bottom of the U-channels is secured to an underside of the joists.

5. The overhead storage access system of claim 1 wherein the beams are secured both to an underside of the joists and to a vertical side region of the joists.

6. The overhead storage access system of claim 1 wherein the lift further comprises a second vertical lifting pillars, a horizontal member coupled to the vertical lifting pillars and the second vertical lifting pillar.

7. The overhead storage access system of claim 1 wherein the platform comprises a first surface secured to the movable frame and a second surface generally parallel with the first surface and extensibly coupled below the first surface, wherein the second surface is wider than the first surface in a lateral direction such that the second surface contacts the ceiling as the movable frame is raised, and wherein the ceiling causes the second surface to extend from the first surface and remain flush against the ceiling while the first surface is lifted above the second surface, wherein the second surface is held to the first surface by an elastic member that moves between an extended state and a retracted state, wherein in the retracted state the first and second surfaces are contacting one another.

8. The overhead storage access system of claim 1 wherein the platform comprises a light fixture on an underside of the platform.

9. The overhead storage access system of claim 1 wherein the platform comprises drawers coupled to an underside of the platform, wherein the drawers are positioned below the ceiling when the movable frame is fully raised.

10. The overhead storage access system of claim 1 wherein the platform comprises a base frame extending upward from the platform to prevent objects from rolling off the platform.

11. The overhead storage access system of claim 10 wherein the base frame is hingedly coupled to the platform, wherein the base frame is permitted to lower to permit objects to roll off the platform when desired.

12. An overhead storage access system, comprising:
beams attached to joists in a ceiling, wherein the beams are transverse to the joists and are attached to an underside of the joists from below the joists;
frame members coupled to the beams and extending upwardly from the beams;
a lifting device supported by the frame members; and
a platform coupled to the lifting device and being configured to raise and lower relative to the beams and frame members as directed by the lifting device.

13. The overhead storage access system of claim 12, further comprising lifting pillars coupled to the platform, wherein the lifting device is configured to attach to the lifting pillars.

14. The overhead storage access system of claim 13 wherein the lifting pillars comprise a vertical portion, an angled portion, and a horizontal portion.

15. A method of installing an overhead storage access unit, comprising:
attaching a first beam to two separate apart joists in a ceiling;
attaching a second beam to the same two separate joists, with the first and second beams attached to at least one of an underside of the joists, a vertical side region of the joists, or both the underside and vertical side region of the joists;
attaching a lifting device to the beams; and
attaching a lift to the lifting device;
wherein the lifting device comprises a motor driving a drum and a line that is wound around the drum to raise the lift to a raised position above the ceiling and unwound from around the drum to lower the lift to a lowered position below the ceiling, and wherein the motor is configured to raise and lower the lift in response to an instruction from a controller.

16. The method of claim 15 wherein attaching two or more beams to the two or more joists is achieved by an installer without the installer entering an area above the joists.

17. The method of claim 15 wherein attaching the beams to the joists comprises bolting a U-shaped channel to an underside of the joists with a flat bottom of the U-shaped channel against the underside of the joists.

18. The method of claim 15, further comprising attaching a stationary frame member to the beams, and wherein the lifting device is attached to the stationary frame member.

19. The method of claim 15, further comprising attaching the controller to one of the beams.

20. The method of claim 15, further comprising attaching the first and second beams to three joists.
